(19) United States
(12) Patent Application Publication
(10) Pub. No.: US 2010/0145988 A1
(43) Pub. Date: Jun. 10, 2010

(54) IMAGE PROCESSING APPARATUS, METHOD FOR MANAGING IMAGE DATA, AND COMPUTER-READABLE STORAGE MEDIUM FOR COMPUTER PROGRAM

(75) Inventor: Kenji MATSUI, Toyokawa-shi (JP)

Correspondence Address: BUCHANAN, INGERSOLL & ROONEY PC, POST OFFICE BOX 1404, ALEXANDRIA, VA, 22313-1404, US

(73) Assignee: KONICA MINOLTA BUSINESS TECHNOLOGIES, INC., Chiyoda-ku (JP)

(21) Appl. No.: 12/632,092

(22) Filed: Dec. 7, 2009

(30) Foreign Application Priority Data
Dec. 10, 2008 (JP) 2008-314053

(51) Int. Cl. G06F 17/30

(52) U.S. Cl. 707/770; 707/769; 707/E17.014; 707/E17.017

(57) ABSTRACT

An image forming apparatus (1) is provided with a mass storage (10d) that stores a file (5) of an image read with a scanner in association with a file name for distinguishing the file 5 from other files (5), a file search portion (104) that carries out a search for files 5 of images containing a keyword specified by a user, and a file name updating portion (106) that updates a file name of a file (5) selected, by the user, from among files (5) found out by the search to the keyword.

This application is based on Japanese patent application No. 2008-314053 filed on Dec. 10, 2008, the contents of which are hereby incorporated by reference.

### BACKGROUND OF THE INVENTION

1. Field of the Invention

The present invention relates to an image processing apparatus, a method, and the like for managing image data obtained by, for example, scanning an image.

2. Description of the Related Art

Image forming apparatuses called “multifunction devices”, “Multi-Function Peripherals (MFPs)”, or the like have come into widespread use in offices of business and homes. Such image forming apparatuses are configured to integrate, thereinto, a variety of functions, such as copying, network printing (PC printing), faxing, and scanning.

Such an image forming apparatus has recently been provided with a mass storage medium, e.g., a hard disk, which has enabled the image forming apparatus to store many files obtained by using a scanning function. Thus, the image forming apparatus has come to be used also as a file server.

In general, files stored in a certain directory, which is sometimes called a “folder” or a “box”, need to have different file names. The image forming apparatus, therefore, assigns a unique file name to a file obtained by using the scanning function. At this time, in order to avoid duplication of file names, a file is usually named in a manner to include numbers representing a date and time on which the file is generated, e.g., year, month, date, hour, minute, and second.

Such a file name, however, confuses a user because the file name is irrelevant to the content of the file.

There are proposed methods for naming a file in such a manner that a user can easily find the file (Japanese Laid-open Patent Publication Nos. 2000-200158, 2002-074321, 2004-140551, and 2006-211261).

The individual methods described in Japanese Laid-open Patent Publication Nos. 2000-200158, 2002-074321, and 2004-140551 involve reading graphic characters recorded in a predetermined area of an original to create a file name.

The method described in Japanese Laid-open Patent Publication No. 2006-211261 involves the following: reading an original image; recognizing characters; storing the characters sequentially; extracting character strings (words and phrases); and extracting a character string with a high frequency of appearance. The method further involves the following: determining that the extracted character string is not a line boundary character; and if a user determines that the extracted character string is suitable for a file name, then using the extracted character string as a file name.

The methods described in Japanese Laid-open Patent Publication Nos. 2000-200158, 2002-074321, 2004-140551, and 2006-211261 are to determine a file name upon reading an original image.

Incidentally, after generating a file, a user sometimes desires to change a file name thereof. An input device used in an image forming apparatus, such as a touch screen, has less operational flexibility than an input device used in a personal computer, such as a keyboard. In view of this, an image forming apparatus is desired which enables a user to change a file name easily.

### SUMMARY

The present disclosure is directed to solve the problems pointed out above, and therefore, an object of an embodiment of the present invention is to provide an apparatus, a method, and the like that enable a user to change a file name more easily than is conventionally possible.

According to an aspect of the present invention, an image processing apparatus includes a reader that reads an image, a part or entirety of which represents a character string, a storage portion that stores image data based on which the image thus read is reproduced in association with identification information for distinguishing the image data from another image data, a search portion that carries out a search for one or more pieces of image data corresponding to one or more images, a part or entirety of which represents the character string that contains a specified keyword, and a modification portion that changes, to the specified keyword, the identification information of image data selected from among said one or more pieces of image data found out by the search.

These and other characteristics and objects of the present invention will become more apparent by the following descriptions of preferred embodiments with reference to drawings.

### BRIEF DESCRIPTION OF THE DRAWINGS

FIG. 1 is a diagram illustrating an example of a network system including an image forming apparatus.

FIG. 2 is a diagram illustrating an example of the hardware configuration of an image forming apparatus.

FIG. 3 is a diagram illustrating an example of the functional configuration of an image forming apparatus.

FIG. 4 is a diagram illustrating an example of a menu screen.

FIG. 5 is a diagram illustrating an example of a file list screen.

FIG. 6 is a diagram illustrating an example of a search command screen.

FIG. 7 is a diagram illustrating an example of a search result screen.

FIG. 8 is a flowchart illustrating an example of the overall processing flow of an image forming apparatus.

FIG. 9 is a diagram illustrating an example of a file list screen.

FIG. 10 is a diagram illustrating an example of the functional configuration of an image forming apparatus.

FIGS. 11A-11C are diagrams illustrating examples of first file name information.

FIG. 12 is a diagram illustrating an example of a file list screen.

FIG. 13 is a diagram illustrating an example of a file list screen.

FIG. 14 is a diagram illustrating an example of the functional configuration of an image forming apparatus.

FIGS. 15A and 15B are diagrams illustrating examples of second file name information.

FIG. 16 is a flowchart illustrating an example of the flow of a file name determination process.

### DESCRIPTION OF THE PREFERRED EMBODIMENTS

### First Embodiment

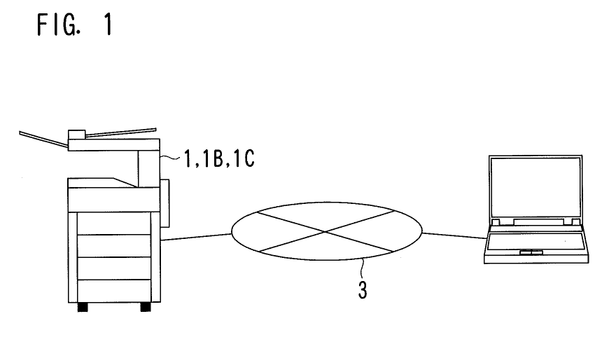

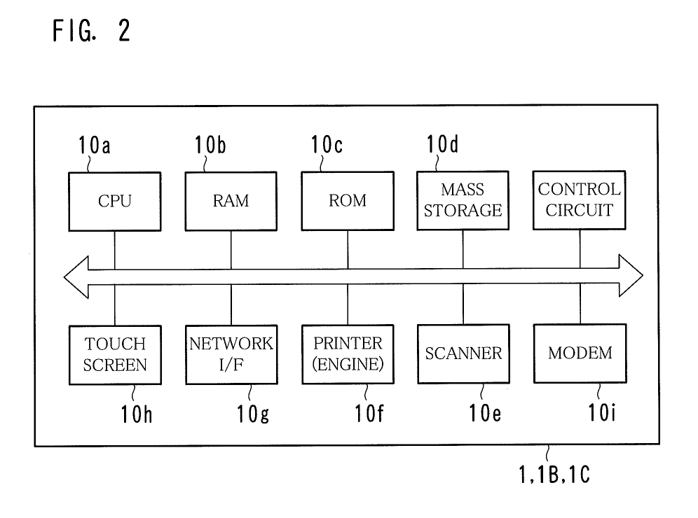

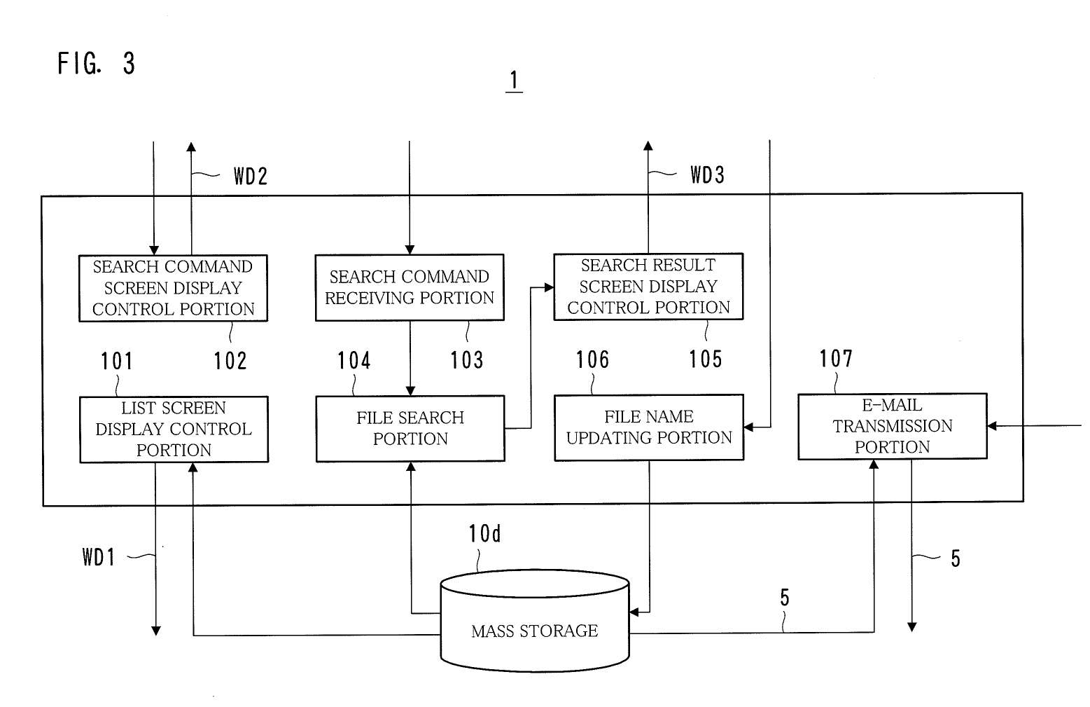

FIG. 1 is a diagram illustrating an example of a network system including an image forming apparatus 1; FIG. 2 is a diagram illustrating an example of the hardware configuration of the image forming apparatus 1; and FIG. 3 is a diagram illustrating an example of the functional configuration of the image forming apparatus 1.

The image forming apparatus 1 illustrated in FIG. 1 is an apparatus generally called a multifunction device, a Multi-Function Peripheral (MFP), or the like. The image forming apparatus 1 is configured to integrate, thereinto, a variety of functions, such as copying, network printing (PC printing), faxing, scanning, and E-mailing.

The image forming apparatus 1 is configured to transmit an electronic file (hereinafter referred to as a “file” simply) to a device such as a personal computer through a communication line 3, e.g., a Local Area Network (LAN), a public line, or the Internet, and also to receive a file from such a device therethrough.

Referring to FIG. 2, the image forming apparatus 1 is configured of a Central Processing Unit (CPU) 10a, a. Random Access Memory (RAM) 10b, a Read-Only Memory (ROM) 10c, a mass storage 10d, a scanner 10e, a printer 10f, a network interface 10g, a touch screen 10h, a modem 10i, a control circuit, and so on.

The scanner 10e is a device that reads images printed on paper, such as photographs, characters, drawings, diagrams, and the like, and creates image data thereof.

The printer 10f serves to print, onto paper, an image obtained by scanning with the scanner 10e or an image included in image data received from another device.

The touch screen 10h displays, for example, a screen for giving a message or instructions to a user, a screen for the user to enter a process command and process conditions, and a screen displaying the result of a process performed by the CPU 10a. The touch screen 10h also detects a position thereof touched by the user with his/her finger and sends a signal indicating the result of the detection to the CPU 10a.

The network interface 10g is a Network Interface Card (NIC) for communicating with another device such as a personal computer via the communication line 3.

The modem 10i is a device for transmitting image data via a fixed-line telephone network to another facsimile terminal and vice versa based on a protocol such as G3.

Referring to FIG. 3, the ROM 10c or the mass storage 10d stores programs for implementing functions of a list screen display control portion 101, a search command screen display control portion 102, a search command receiving portion 103, a file search portion 104, a search result screen display control portion 105, a file name updating portion 106, an e-mail transmission portion 107, and the like. An example of the mass storage 10d is a hard disk or a flash memory. These programs are loaded into the RAM 10b as necessary, whereupon the programs are executed by the CPU 10a.

The ROM 10c or the mass storage 10d further stores programs for implementing an Optical Character Reader (OCR) function, a Portable Document Format (PDF) file generation function, and a file server function.

The OCR function is used to recognize which characters are represented by character images contained in an image obtained by scanning with the scanner 10e, and to generate text data in which the recognized characters are indicated.

The PDF file generation function is used to generate a PDF file of an image obtained by scanning with the scanner 10e. In the case where an image obtained by scanning contains a character image, a PDF file is generated in such a manner to contain text data generated by using the OCR function.

The file server function is used to control the mass storage 10d in such a manner that a file generated by, for example, using the PDF file generation function is saved therein, or to call a file saved therein.

The whole or a part of the functions of the individual portions illustrated in FIG. 3, the OCR function, and the like may be implemented merely by hardware such as a circuit.

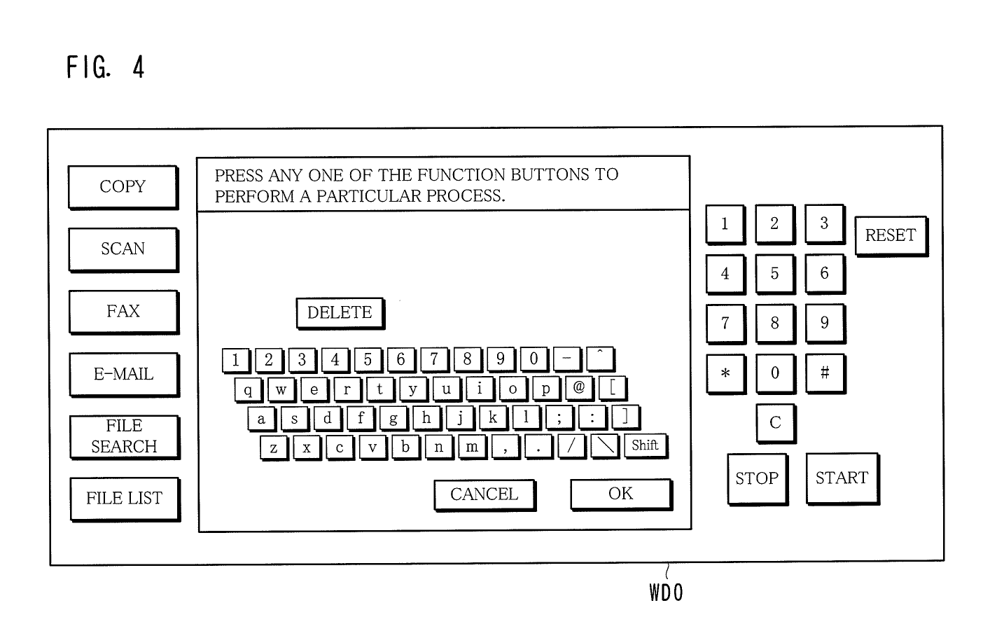

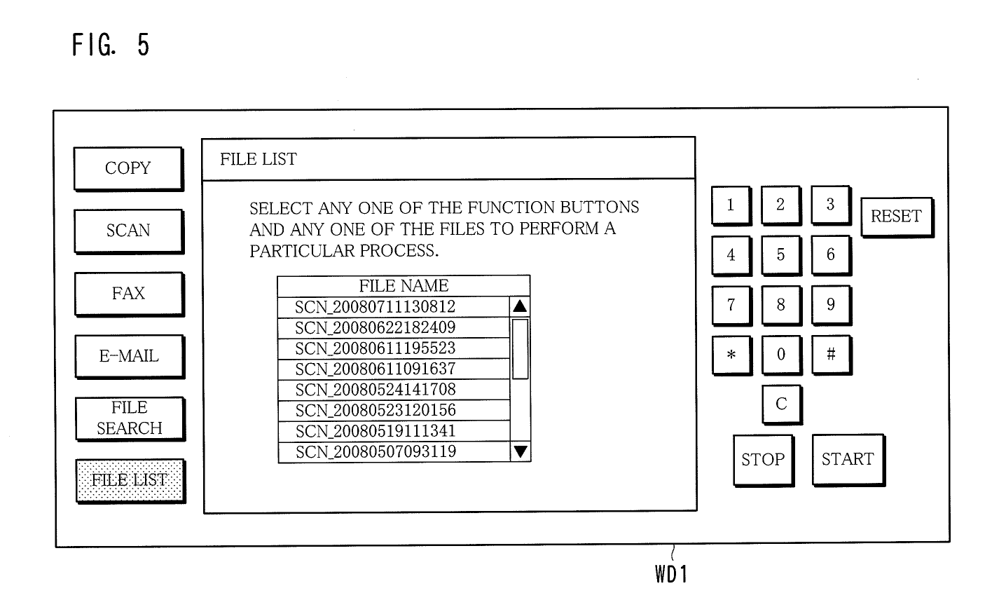

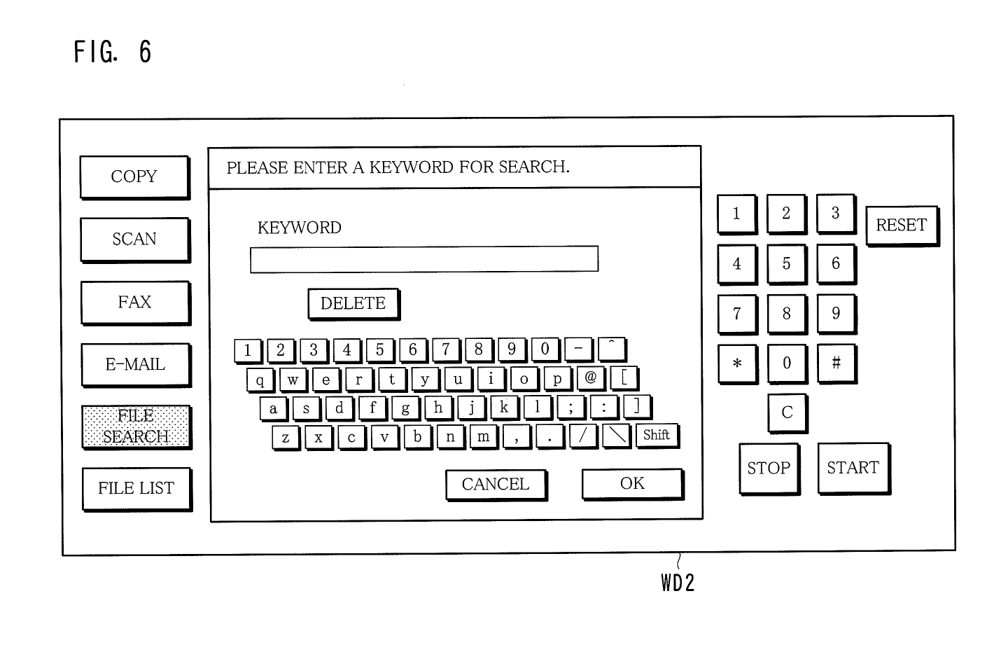

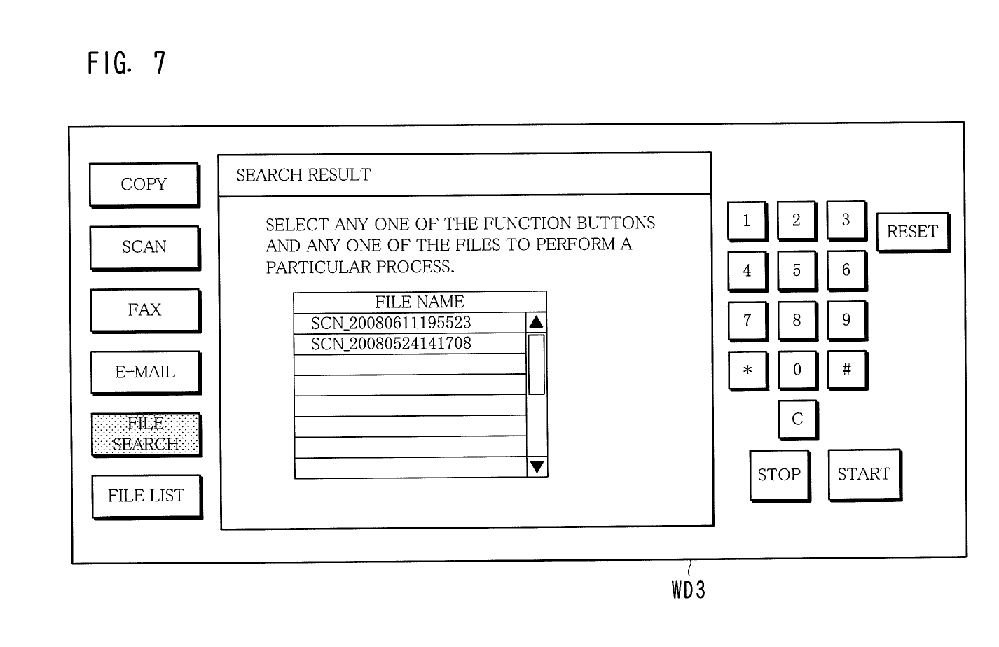

FIG. 4 is a diagram illustrating an example of a menu screen WD0; FIG. 5 is a diagram illustrating an example of a file list screen WD1; FIG. 6 is a diagram illustrating an example of a search command screen WD2; and FIG. 7 is a diagram illustrating an example of a search result screen WD3.

The following is a description of the details of processing performed by the individual portions of the image forming apparatus 1 illustrated in FIG. 3.

When a user logs onto the image forming apparatus 1 or enters a predetermined command, the menu screen WD0 as illustrated in FIG. 4 is displayed on the touch screen 10h. The user operates the menu screen WD0 or the like to cause the image forming apparatus 1 to carry out a process the user desires to be performed.

For example, in the case where the user desires to convert an image printed on paper into electronic data, he/she places the paper onto a document tray of the image forming apparatus 1, presses a “SCAN” button, and then presses a “START” button. In response to this, the image forming apparatus 1 generates image data of the image printed on the paper with the scanner 10e. The image forming apparatus 1 further uses the OCR function to generate text data as described above, and then uses the PDF file generation function to generate a PDF file. Hereinafter, a file containing data representing text, such as a file generated in this manner, is referred to as a “file 5”.

Incidentally, a file name of the file 5 is determined based on a predetermined rule. The file name “SCAN_{—}20080524141708” is taken as an example. The file name is a character string that is a combination of a header including a predetermined character string and numbers representing a date and time on which the file 5 is generated, e.g., year, month, date, hour, minute, and second.

The user presses a “FILE LIST” button to view a list of the files 5 stored in the mass storage 10d.

In response to this, the list screen display control portion 101 causes the touch screen 10h to display the file list screen WD1, as illustrated in FIG. 5, showing a list of the files 5 stored in the mass storage 10d.

The user presses a “FILE SEARCH” button to search for files 5 stored in the mass storage 10d. In response to this, the search command screen display control portion 102, the search command receiving portion 103, and the file search portion 104 illustrated in FIG. 3 perform a process for searching for files 5 in the mass storage 10 in the following manner.

The search command screen display control portion 102 causes the touch screen 10h to display the search command screen WD2 as illustrated in FIG. 6. The user enters a character string, as a keyword for search, in a text box, and presses an “OK” button.

The search command receiving portion 103 receives, as a keyword for search, the character string entered in the text box.

The file search portion 104 searches for files 5 containing text data in which the keyword is indicated.

The search result screen display control portion 105 displays the search result screen WD3, as illustrated in FIG. 7, showing a list of the files 5 found by the search carried out by the file search portion 104, that is to say, showing the search result.

The user may select a file 5 from the list of the files 5 in the file list screen WD1 or the search result screen WD3 to cause the image forming apparatus 1 to perform a process using the selected file 5.

In the case where, for example, the user desires to attach the file 5 to an electronic mail and send the electronic mail, he/she selects a file name corresponding to the file 5 from the list of the files 5 and presses an “E-MAIL” button.

In response to this, the file name updating portion 106 performs a process for updating (changing) the selected file name corresponding to the file 5. The e-mail transmission portion 107 performs a process for sending the file 5 as described below.

To be specific, the file name updating portion 106 updates the selected file name of the file 5 to indicate, as a file name thereof, the keyword that the user has entered for a search in the text box of the search command screen WD2.

The e-mail transmission portion 107 causes the touch screen 10h to display a screen for the user to enter an electronic mail address to which an electronic mail is to be sent. The user enters an electronic mail address of a party to whom the user intends to send the file 5. Then, the e-mail transmission portion 107 generates an electronic mail to which the selected file 5 is attached and sends the electronic mail to the electronic mail address entered by the user. Note that the file name updated as described above, i.e., the keyword entered, as the file name, by the user is used as a file name of the file 5 to be sent.

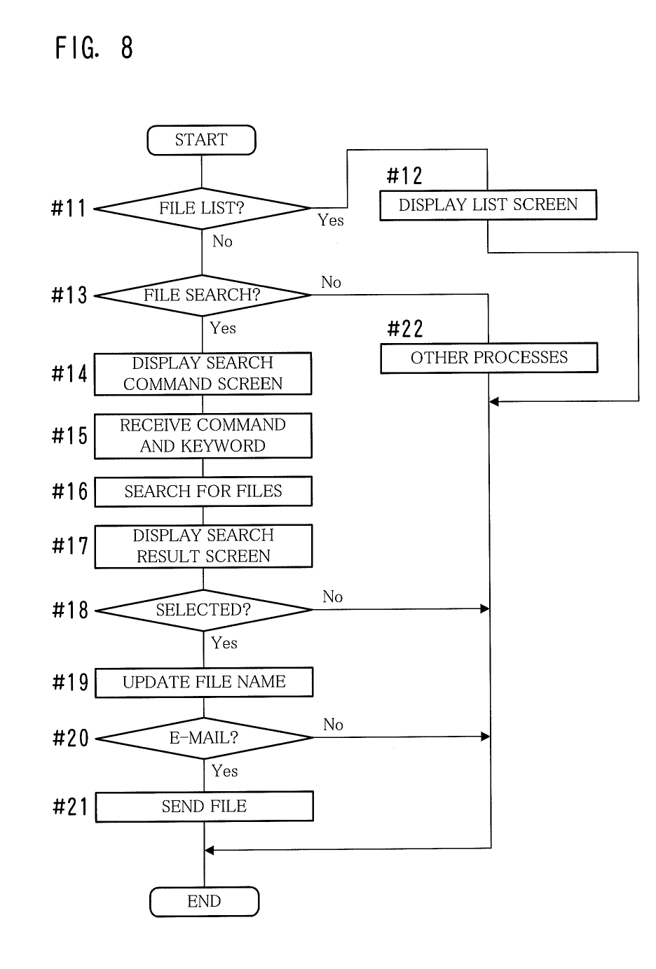

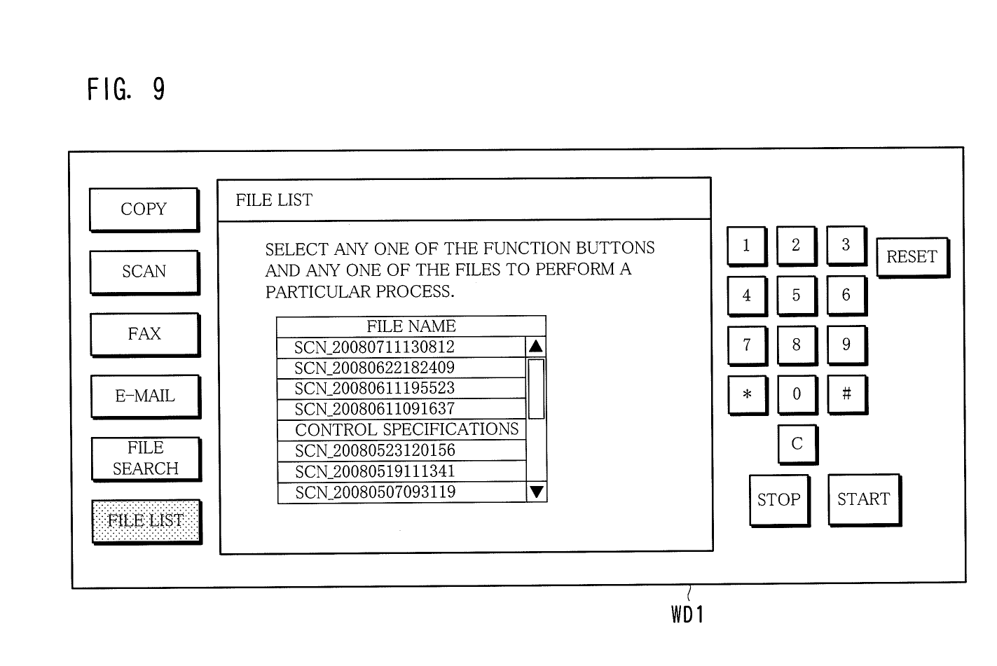

FIG. 8 is a flowchart illustrating an example of the overall processing flow of the image forming apparatus 1; and FIG. 9 is a diagram illustrating an example of the file list screen WD1.

The following is a description of the overall processing flow of the image forming apparatus 1 with reference to the flowchart in FIG. 8.

The image forming apparatus 1 carries out the following process in response to an operation performed by a user.

If the user presses the “FILE LIST” button on the menu screen WD0 (see FIG. 4) (Yes in #11), then the image forming apparatus 1 displays the file list screen WD1 (see FIG. 5) showing a list of files 5 stored in the mass storage 10d (#12).

If the user presses the “FILE SEARCH” button (No in #11 and Yes in #13), then the image forming apparatus 1 displays the search command screen WD2 (see FIG. 6) (#14). If the user enters a keyword in a text box, presses the “OK” button, and instructs the image forming apparatus 1 to carry out a search, then the image forming apparatus 1 receives the instructions and the keyword (#15), and searches, in the mass storage 10d, for files 5 containing text data in which the keyword is indicated (#16). Then, the image forming apparatus 1 displays the search result screen WD3 (see FIG. 7) showing a result of the search (#17).

The user can select any one of the files 5 found by the search and cause the image forming apparatus 1 to perform a process the user desires to be performed. If the user selects any one of the files 5 from a list of the files 5 in the search result screen WD3 (Yes in #18), then the image forming apparatus 1 updates a file name of the selected file 5 to the keyword received, as a file name thereof, in Step #15 (#19).

If the user presses the “E-MAIL” button after selecting the file 5 (Yes in #20), then the image forming apparatus 1 generates an electronic mail to which the selected file 5 is attached and sends the electronic mail to an electronic mail address specified by the user (#21).

If the user performs an operation other than those described above (No in #11 and No in #13), then the image forming apparatus 1 performs a process in accordance with the operation performed by the user as with the conventional technique (#22).

Suppose that the user uses “control specifications”, as a keyword, to cause the image forming apparatus 1 to search for files 5, selects the second file 5 from the list in the search result screen WD3 illustrated in FIG. 7, and then presses the “FILE LIST” button (Yes in #11). In such a case, the image forming apparatus 1 displays the file list screen WD1 showing the updated file name as illustrated in FIG. 9.

The first embodiment enables a user to change a file name of a file 5 stored in the mass storage 10d more easily than is conventionally possible.

### Second Embodiment

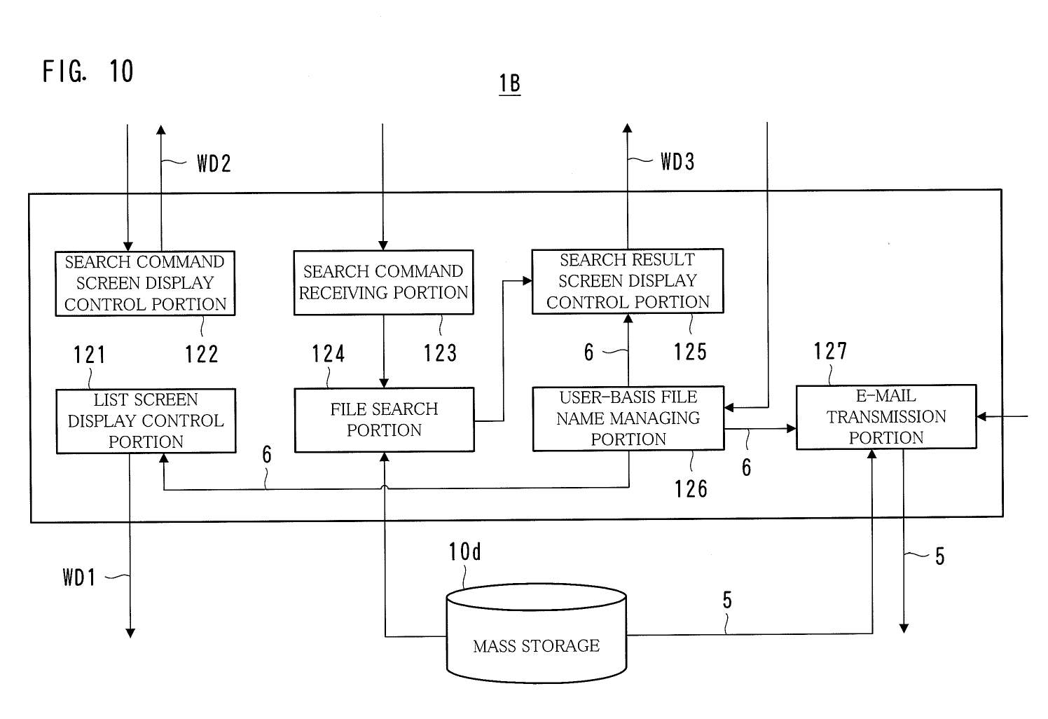

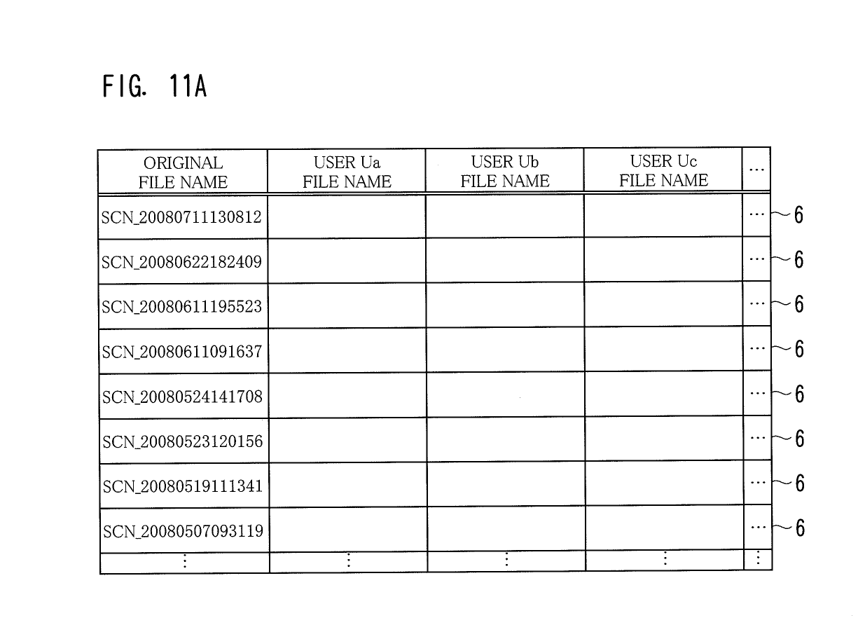

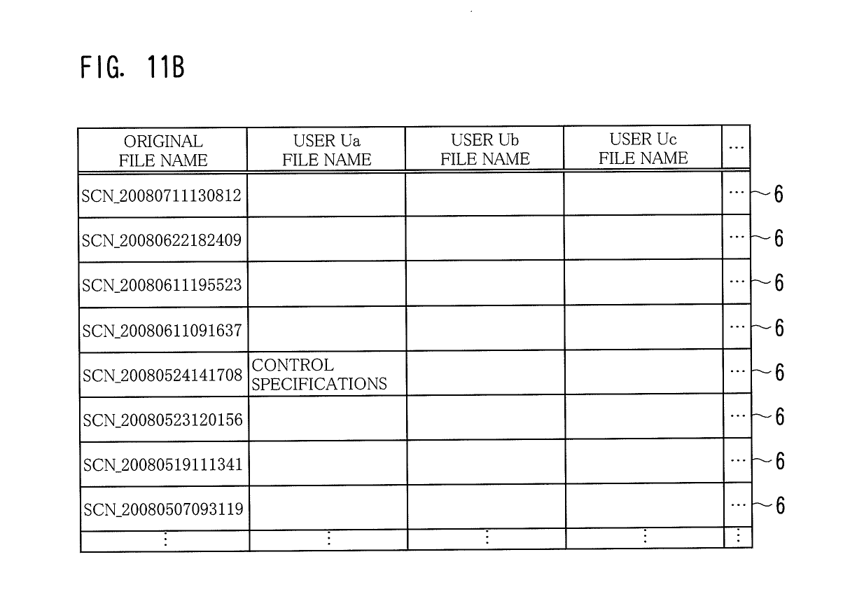

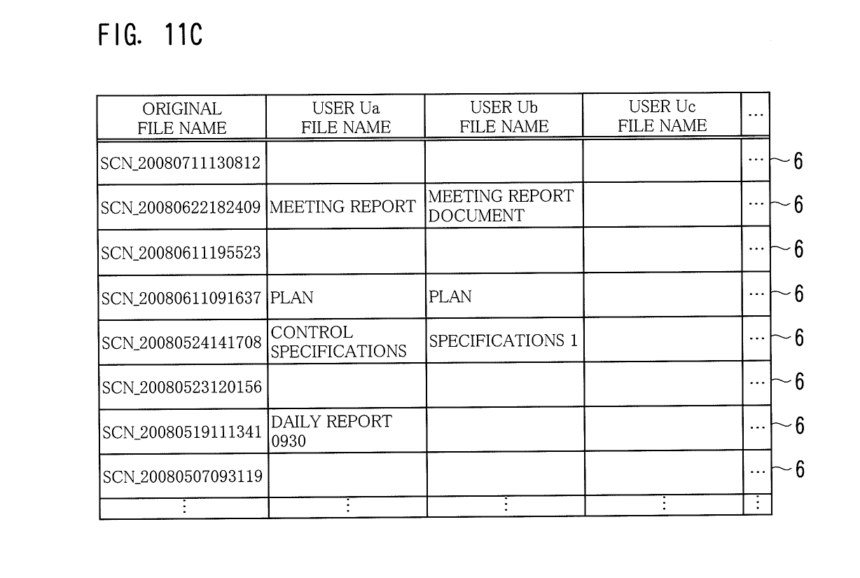

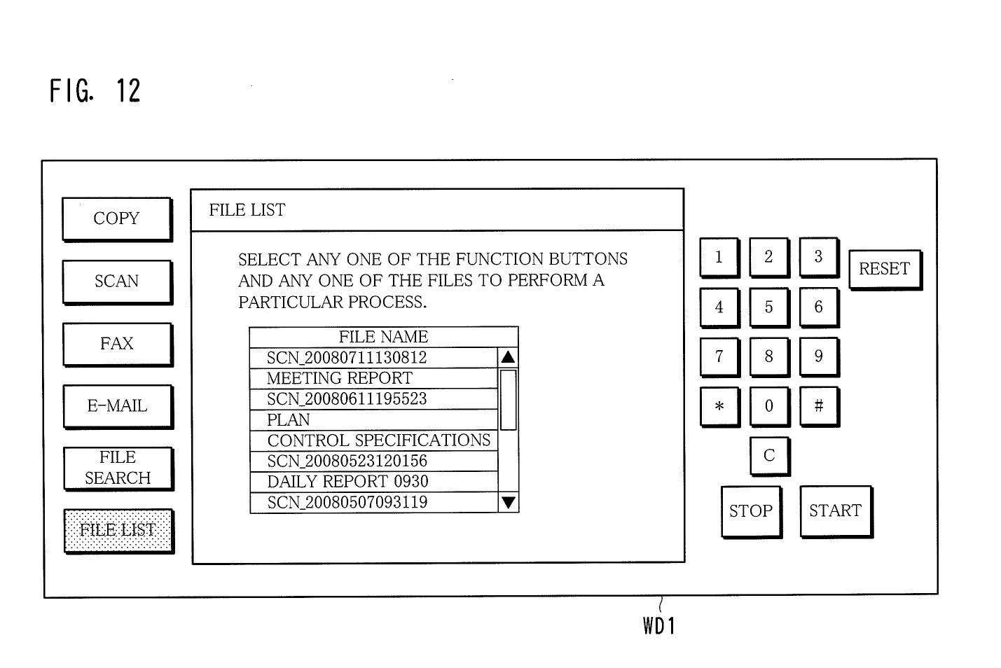

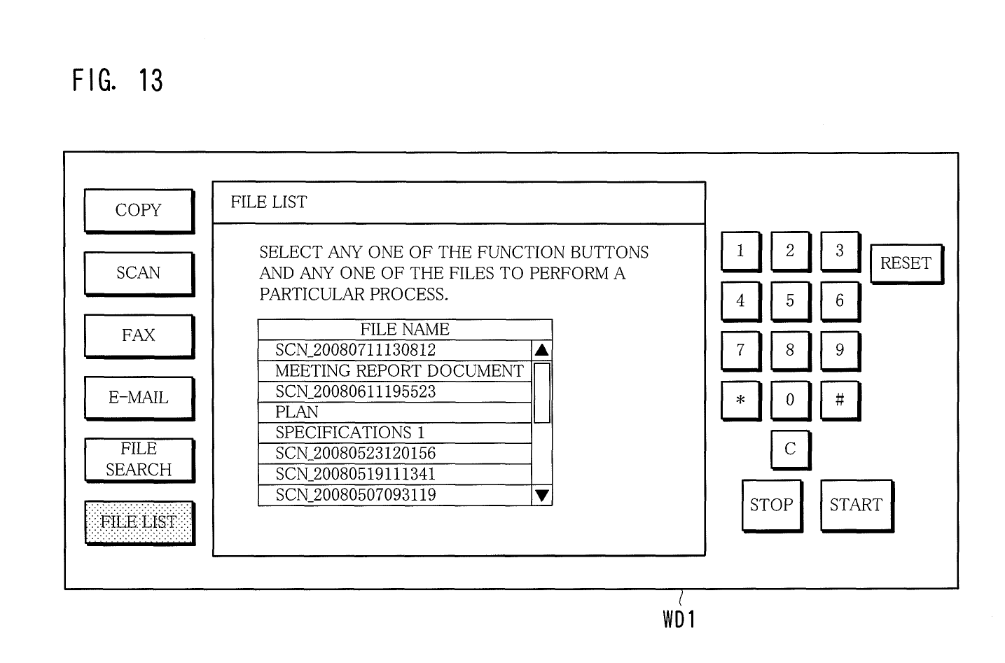

FIG. 10 is a diagram illustrating an example of the functional configuration of an image forming apparatus 1B; FIGS. 11A-11C are diagrams illustrating examples of first file name information 6; and FIGS. 12 and 13 are diagrams illustrating examples of a file list screen WD1.

In the first embodiment, the image forming apparatus 1 updates a file name of a file 5 selected by a user to a keyword entered on the search command screen WD2, independent of who instructs the image forming apparatus 1 to search for files 5 and selects a file 5 in the search result screen WD3 (see FIG. 7).

In contrast, according to the second embodiment, the image forming apparatus 1B is configured to update a file name of a selected file 5 in such a manner that the file name is different for each user.

The hardware configuration of the image forming apparatus 1B according to the second embodiment is similar to that of the image forming apparatus 1 illustrated in FIG. 2 according to the first embodiment.

The mass storage 10d of the image forming apparatus 1B, however, instead of the programs for implementing the functions of the individual portions illustrated in FIG. 3, stores programs for implementing functions of a list screen display control portion 121, a search command screen display control portion 122, a search command receiving portion 123, a file search portion 124, a search result screen display control portion 125, a user-basis file name managing portion 126, an e-mail transmission portion 127, and the like (see FIG. 10). As with the first embodiment, the mass storage 10d of the image forming apparatus 1B stores programs for implementing an OCR function, and so on.

The mass storage 10d further stores a plurality of files 5 obtained by using the scanning function, the OCR function, and the PDF file generation function.

The following is a description of the details of processing performed by the individual portions of the image forming apparatus 1B, focusing on the differences between the first embodiment and the second embodiment. Descriptions of points that are identical with those in the first embodiment are omitted.

The search command screen display control portion 122, the search command receiving portion 123, the file search portion 124, and the search result screen display control portion 125 perform basically the same processes as the search command screen display control portion 102, the search command receiving portion 103, the file search portion 104, and the search result screen display control portion 105 in the first embodiment, respectively.

To be specific, the search command screen display control portion 122 causes the touch screen 10h to display the search command screen WD2 as illustrated in FIG. 6. The search command receiving portion 123 receives a search command and a search keyword. The file search portion 124 searches for files 5 in the mass storage 10d based on the received keyword. The search result screen display control portion 125 causes the touch screen 10h to display the search result screen WD3, as illustrated in FIG. 7, showing a list of the files 5 found by the search.

As with the first embodiment, a user may select a file 5 from a list of files 5 in the search result screen WD3, attach the selected file 5 to an electronic mail, and output the electronic mail. After the user selects the file 5, a file name of the selected file 5 is updated (changed) to a keyword that the user has entered (specified) for a search. Unlike the first embodiment, however, a file name of the file 5 is updated in such a manner that the file name is different for each user as discussed earlier. How this is performed is detailed below.

As illustrated in FIG. 11A, the user-basis file name managing portion 126 stores and manages first file name information 6 for each file 5 saved in the mass storage 10d. Every time a new file 5 is saved (stored) in the mass storage 10d, the user-basis file name managing portion 126 generates first file name information 6 for the new file 5 and stores the same.

Referring to FIGS. 11A-11C, the field named “ORIGINAL FILE NAME” of the first file name information 6 indicates a file name originally assigned to the file 5. The fields named “USER Ua FILE NAME”, “USER Ub FILE NAME”, “USER Uc FILE NAME”, and so on respectively indicate file names used for cases where users Ua, Ub, Uc, and so on are informed of the file 5. Default values in fields other than the “ORIGINAL FILE NAME” field are Null.

Every time a user selects any one of the files 5 found by the search, the user-basis file name managing portion 126 updates a field of the user in the first file name information 6 corresponding to the selected file 5 to indicate a keyword that the user has entered for a search. Stated differently, the first file name information 6 indicates a history of keywords used for searches on a user-by-user basis.

For example, suppose that the user Ua uses a keyword “control specifications” to cause the image forming apparatus 1B to carry out a search, obtains the result of the search as illustrated in FIG. 7, and selects the second file 5 from the list of the files 5 found by the search. In such a case, the “USER Ua FILE NAME” field of the first file name information 6 corresponding to the selected file 5 is updated in such a manner that the “control specifications” is indicated therein as illustrated in FIG. 11B.

The list screen display control portion 121 causes the touch screen 10h to display the file list screen WD1 as illustrated in FIG. 5 in a manner similar to the list screen display control portion 101 in the first embodiment. The list screen display control portion 121, however, causes the touch screen 10h to display the file list screen WD1 based on fields for users in the first file name information 6 for each file 5. Accordingly, in some cases, a file name of a file 5 indicated in the file list screen WD1 is different depending on a user using (logging onto) the image forming apparatus 1B.

In the case where, for example, the details of the first file name information 6 of the individual files 5 stored in the mass storage 10d are specified as illustrated in FIG. 11C, and the user Ua uses the image forming apparatus 1B, the list screen display control portion 121 causes the touch screen 10h to display the file list screen WD1 as illustrated in FIG. 12. In the case where, for example, the details of the first file name information 6 of the individual files 5 stored in the mass storage 10d are specified as illustrated in FIG. 11C, and the user Ub uses the image forming apparatus 1B, the list screen display control portion 121 causes the touch screen 10h to display the file list screen WD1 as illustrated in FIG. 13.

As with the e-mail transmission portion 107 in the first embodiment, the e-mail transmission portion 127 generates an electronic mail to which a file 5 selected by a user is attached, and sends the electronic mail to an electronic mail address specified by the user. The file name of the file 5 is, however, different depending on a user who has commanded to send the electronic mail, i.e., a user who logs onto the image forming apparatus 1B. To be specific, a file name indicated in a field of the user in the first file name information 6 for the file 5 is used as a file name of the file 5.

The overall processing flow of the image forming apparatus 1B in the second embodiment is basically the same as that in the first embodiment as discussed earlier with reference to FIG. 8.

In Step #12, however, the image forming apparatus 1B determines a file name of a file 5 as described below. If first file name information 6 for the file 5 indicates a file name (keyword) in a field of a user logging onto the image forming apparatus 1B, then the image forming apparatus 1B determines to use the indicated file name as a file name of the file 5. If the first file name information 6 for the file 5 does not indicate such a file name (keyword) therein, then the image forming apparatus 1B determines to use a file name specified in the “ORIGINAL FILE NAME” field as a file name of the file 5. The same applies to Step #17.

If the user selects a file 5 from a list of files 5 in the search result screen WD3, then in Step #19 the image forming apparatus 1B writes a keyword that the user has entered for a search into a field of the user in the first file name information 6 corresponding to the file 5.

In Step #21, if first file name information 6 for a file 5 to be sent indicates a file name (keyword) in a field of a user logging onto the image forming apparatus 1B, then the image forming apparatus 1B uses the indicated file name as a file name of the file 5 to send an electronic mail to which the file 5 is attached.

In the second embodiment, even if a plurality of users use one file 5, it is possible for the users to easily change a file name of the file 5 on a user-by-user basis.

### Third Embodiment

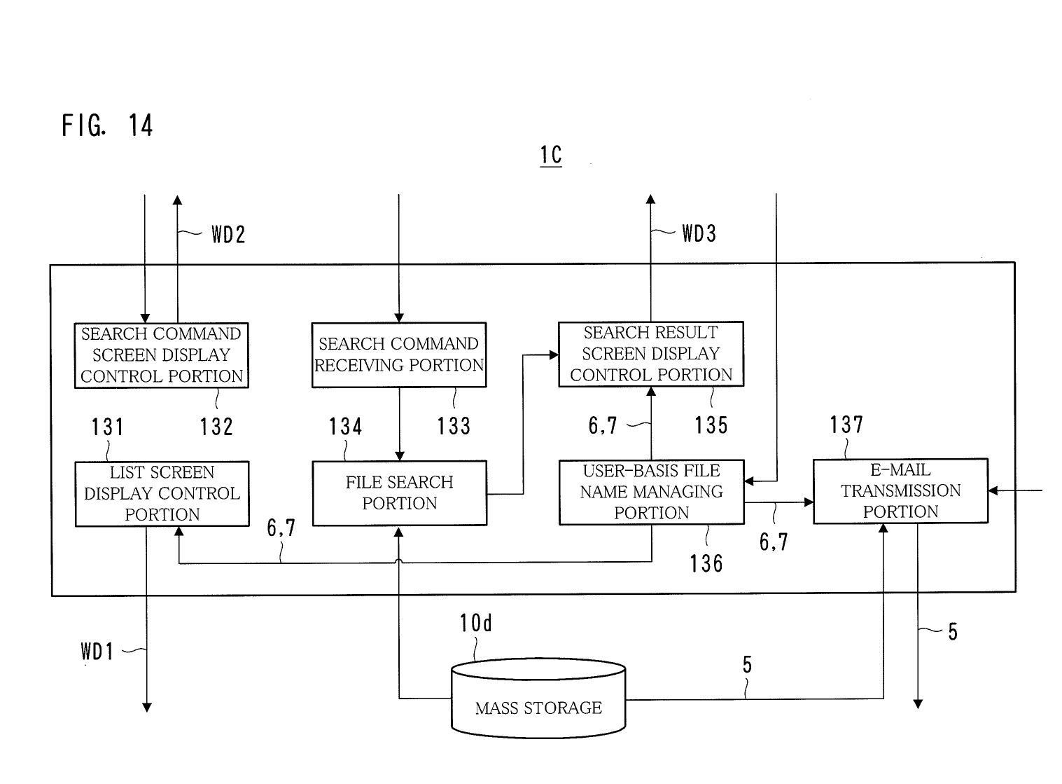

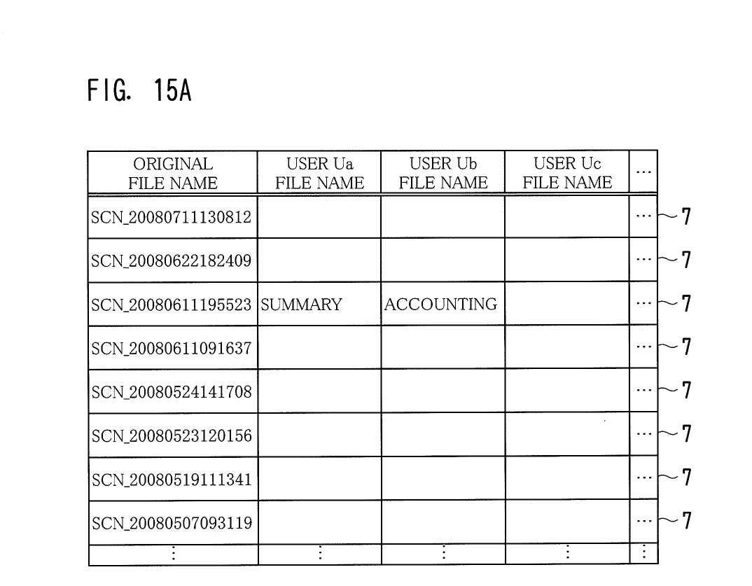

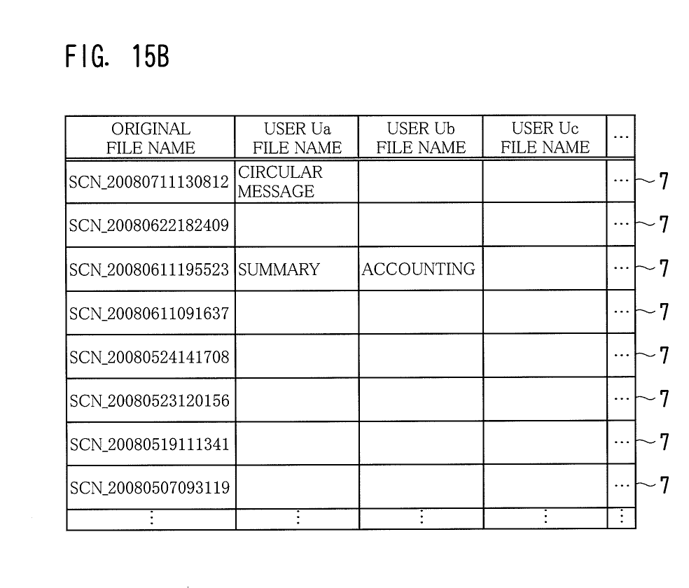

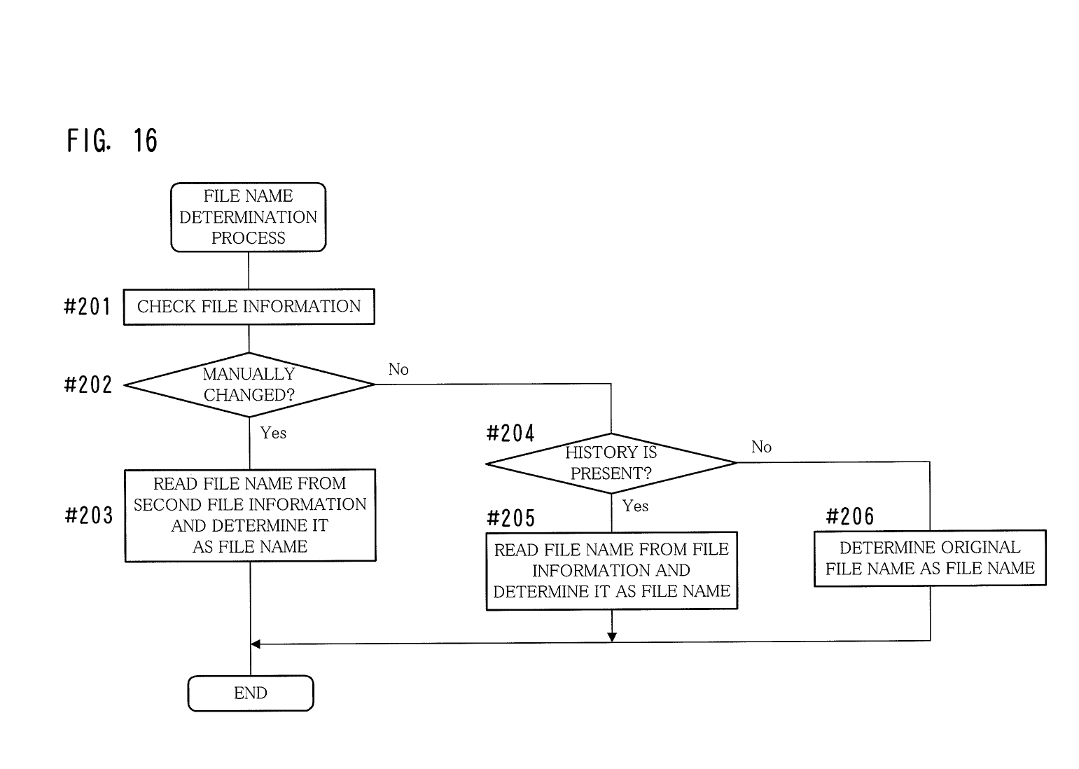

FIG. 14 is a diagram illustrating an example of the functional configuration of an image forming apparatus 1C; FIGS. 15A and 15B are diagrams illustrating examples of second file name information 7; and FIG. 16 is a flowchart illustrating an example of the flow of a file name determination process.

A user can assign a file name to a file 5 on his/her own according to a conventional manner. In view of this, in the third embodiment, the image forming apparatus 1C is configured to give a priority to a file name assigned by a user and display the file list screen WD1, and the like based on the file name assigned by the user.

The hardware configuration of the image forming apparatus 1C according to the third embodiment is similar to those of the image forming apparatuses 1 and 1B according to the first and second embodiments, and is as illustrated in FIG. 2.

The mass storage 10d of the image forming apparatus 1C, however, instead of the programs for implementing the functions of the individual portions illustrated in FIGS. 3 and 10, stores programs for implementing functions of a list screen display control portion 131, a search command screen display control portion 132, a search command receiving portion 133, a file search portion 134, a search result screen display control portion 135, a user-basis file name managing portion 136, an e-mail transmission portion 137, and the like (see FIG. 14). As with the first and second embodiments, the mass storage 10d of the image forming apparatus 1C stores programs for implementing an OCR function, and so on.

The mass storage 10d further stores a plurality of files 5 obtained by using the scanning function, the OCR function, and the PDF file generation function.

The following is a description of the details of processing performed by the individual portions of the image forming apparatus 1C, focusing on the differences between the second embodiment and the third embodiment. Descriptions of points that are identical with those in the second embodiment are omitted.

The search command screen display control portion 132, the search command receiving portion 133, the file search portion 134, and the search result screen display control portion 135 perform basically the same processes as the search command screen display control portion 122, the search command receiving portion 123, the file search portion 124, and the search result screen display control portion 125 in the second embodiment, respectively.

To be specific, the search command screen display control portion 132 causes the touch screen 10h to display the search command screen WD2 as illustrated in FIG. 6. The search command receiving portion 133 receives a search command and a search keyword. The file search portion 134 searches for files 5 in the mass storage 10d based on the received keyword. The search result screen display control portion 135 causes the touch screen 10h to display the search result screen WD3, as illustrated in FIG. 7, showing a list of the files 5 found by the search.

As with the user-basis file name managing portion 126, the user-basis file name managing portion 136 stores and manages first file name information 6 (see FIG. 11) for each file 5 saved in the mass storage 10d. Every time a file 5 is saved in the mass storage 10d, the user-basis file name managing portion 136 generates second file name information 7 for the file 5 and stores the same as illustrated in FIG. 15A.

Referring to FIGS. 15A and 15B, the field named “ORIGINAL FILE NAME” of the second file name information 7, indicates a file name originally assigned to the file 5. The fields named “USER Ua FILE NAME”, “USER Ub FILE NAME”, “USER Uc FILE NAME”, and so on indicate file names that have been assigned to the file 5 respectively by users Ua, Ub, Uc, and so on. Default values in fields other than the “ORIGINAL FILE NAME” field are Null.

In the case where a user changes a file name of a file 5, the user-basis file name managing portion 136 writes the changed file name into a field of the user in the second file name information 7 for the file 5.

Suppose that, for example, the user Ua changes a file name originally assigned to a file 5 (original file name thereof), e.g., a file name “SCN_{—}20080711130812”, to a file name “circular message”. In such a case, as illustrated in FIG. 15B, the user-basis file name managing portion 136 writes “circular message”, as the file name, into the “USER Ua FILE NAME” field of the second file name information 7 for the file 5.

As with the list screen display control portion 121 in the second embodiment, the list screen display control portion 131 causes the touch screen 10h to display the file list screen WD1 as illustrated in FIG. 5. The list screen display control portion 131, however, determines a file name to be indicated in the file list screen WD1 not only based on the first file name information 6 of the individual files 5 but also based on the second file name information 7 thereof. A method for determining a file name is described below with reference to the flowchart in FIG. 16, taking an example of a case in which the user Ua uses the image forming apparatus 1C.

Referring to FIG. 16, the list screen display control portion 131 checks the first file name information 6 and the second file name information 7 of the individual files 5 stored in the mass storage 10d (#201). Then, the list screen display control portion 131 determines what is to be displayed as a file name of each of the files 5, in the following manner.

As for a file 5 corresponding to second file name information 7 indicating a file name in the “USER Ua FILE NAME” field (Yes in #202), the list screen display control portion 131 determines the file name indicated therein to be a file name of the file 5 (#203).

As for a file 5 to which such second file name information 7 does not correspond, but, to which first file name information 6 indicating a file name in the “USER Ua FILE NAME” field corresponds (No in #202 and Yes in #204), the list screen display control portion 131 determines the file name indicated therein to be a file name of the file 5 (#205).

As for a file 5 to which neither such second file name information 7 nor such first file name information 6 corresponds, i.e., as for a file 5 for which the user Ua has never changed the file name on his/her own, and at the same time, that the user Ua has never selected from a search result (No in #202 and No in #204), the list screen display control portion 131 determines a file name originally assigned to the file 5 (original file name) to be a file name of the file 5 (#206).

As with the e-mail transmission portion 127 in the second embodiment, the e-mail transmission portion 137 generates an electronic mail to which a file 5 selected by a user is attached, and sends the electronic mail to an electronic mail address specified by the user. Unlike the second embodiment, however, the third embodiment uses the method discussed above with reference to FIG. 16 as a method for determining a file name of the file 5. To be specific, if the user assigns a file name to the file 5 on his/her own, then the file name assigned by the user takes priority over all other file names. If the user does not assign a file name to the file 5 on his/her own, then the same method as that described in the second embodiment is used as a method for determining a file name of the file 5.

The overall processing flow of the image forming apparatus 1C in the third embodiment is basically the same as those in the first and second embodiments as discussed earlier with reference to FIG. 8.

A method for determining a file name to be displayed on the file list screen WD1, a file name to be displayed on the search result screen WD3, and a file name of a file 5 attached to an electronic mail is the same as that described earlier with reference to FIG. 16.

In the third embodiment, even if a plurality of users use one file 5, it is possible for the users to easily change a file name of the file 5 on a user-by-user basis. In addition, since file names assigned by individual users themselves take priority over all other file names, more recognizable file names can be presented to the users.

The image forming apparatus 1C according to the third embodiment is configured to determine a file name based on the priorities as described earlier with reference to FIG. 16. Instead, however, the image forming apparatus 1C may be so configured that the priorities are optionally determined on a user-by-user basis.

A file name of a file 5 may be an optional combination of a file name indicated in first file name information 6 (keyword for search), a file name indicated in second file name information 7, and a file name originally assigned to the file 5 (original file name).

Suppose that, for example, the user Ua instructs the image forming apparatus 1C to transmit a file 5 via electronic mail under the following two conditions:

(1) Underscores (_) are used to couple, to one another, a file name indicated in the first file name information 6, a file name indicated in the second file name information 7, and an original file name; and
(2) First file name information 6 for the file 5 indicates “ABC report” in the “USER Ua FILE NAME” field, second file name information 7 therefor indicates “reported on April 28” in the “USER Ua FILE NAME” field, and the original file name thereof is “SCN_{—}080425154803.pdf”. In such a case, the file name of the file 5 upon the transmission is determined to be “ABC report_reported on April 28_SCN_{—}080425154803.pdf”.

In the first through third embodiments described above, the file 5 is sent via electronic mail. Instead, however, the file 5 may be sent based on a protocol such as File Transfer Protocol (FTP) or Server Message Block (SMB).

In the first through third embodiments described above, a keyword is searched in text data obtained as a result of an OCR process. Instead, however, a keyword is searched in attribute information, that is, property.

The present invention is applicable to a system in which a personal computer and a scanner are combined together.

In the embodiments discussed above, the overall configurations of the image forming apparatuses 1, 1B, and 1C, the configurations of various portions thereof, the content to be processed, the processing order, and the like may be altered as required in accordance with the subject matter of the present invention.

While example embodiments of the present invention have been shown and described, it will be understood that the present invention is not limited thereto, and that various changes and modifications may be made by those skilled in the art without departing from the scope of the invention as set forth in the appended claims and their equivalents.

What is claimed is:

1. An image processing apparatus comprising:
a reader that reads an image, a part or entirety of which represents a character string;
a storage portion that stores image data based on which the image thus read is reproduced in association with identification information for distinguishing the image data from another image data;
a search portion that carries out a search for one or more pieces of image data corresponding to one or more images, a part or entirety of which represents the character string that contains a specified keyword; and
a modification portion that changes, to the specified keyword, the identification information of image data selected from among said one or more pieces of image data found out by the search.

2. The image processing apparatus according to claim 1, further comprising a transmitter that sends the image data that has been selected from among said one or more pieces of image data to another apparatus after assigning the specified keyword to the image data.

3. An image processing apparatus shared by a plurality of users, the image processing apparatus comprising:
a reader that reads an image, a part or entirety of which represents a character string;
an image data storage portion that stores image data based on which the image thus read is reproduced in association with first identification information for distinguishing the image data from another image data;
a search portion that carries out a search for one or more pieces of image data corresponding to one or more images, a part or entirety of which represents the character string that contains a keyword specified by an active user among the plurality of users, the active user being a user who currently uses the image processing apparatus;
a keyword storage portion that stores the keyword in association with the active user and image data selected by the active user from among said one or more pieces of image data found out by the search; and
a display that displays, if the keyword storage portion stores the keyword associated with the active user and the image data selected by the active user, the keyword to inform the active user of the image data, and displays, if the keyword storage portion does not store the keyword associated with the active user and the image data, the first identification information of the image data to inform the active user of the image data.

4. The image processing apparatus according to claim 3, further comprising an identification information storage portion that stores second identification information assigned to the image data by the active user in association with the image data and the active user, the second identification information being for distinguishing the image data from another image data,
wherein if the identification information storage portion stores the second identification information associated with the image data and the active user, the display displays the second identification information, instead of the keyword and the first identification information, to inform the active user of the image data.

5. The image processing apparatus according to claim 3, further comprising a transmitter that sends the image data selected by the active user from among said one or more pieces of image data found out by the search to another apparatus after assigning, to the image data selected by the active user, the keyword associated with the active user and the image data.

6. The image processing apparatus according to claim 5, further comprising an identification information storage portion that stores second identification information assigned to the image data by the active user in association with the image data and the active user, the second identification information being for distinguishing the image data from another image data, wherein if the identification information storage portion stores the second identification information associated with the active user and the image data selected by the active user from among said one or more pieces of image data found out by the search, the transmitter sends the image data selected by the active user to another apparatus after assigning, to the image data selected by the active user, the second identification information instead of the keyword and the first identification information.

7. An image processing apparatus shared by a plurality of users, the image processing apparatus comprising:
a reader that reads an image, a part or entirety of which represents a character string;
an image data storage portion that stores image data based on which the image thus read is reproduced in association with first identification information for distinguishing the image data from another image data;
a search portion that carries out a search for one or more pieces of image data corresponding to one or more images, a part or entirety of which represents the character string that contains a keyword specified by an active user among the plurality of users, the active user being a user who currently uses the image processing apparatus;
a keyword storage portion that stores the keyword in association with the active user and image data selected by the active user from among said one or more pieces of image data found out by the search;
an identification information storage portion that stores second identification information assigned to the image data by the active user in association with the image data and the active user, the second identification information being for distinguishing the image data from another image data; and
a display that displays a code including at least one of the keyword associated with the active user and the image data, the second identification information associated with the image data and the active user, and the first identification information of the image data to inform the active user of the image data.

8. A method for managing image data in an image processing apparatus, the method comprising:
causing the image processing apparatus to perform:
reading an image, a part or entirety of which represents a character string,
storing, in an image data storage portion, image data based on which the image thus read is reproduced in association with identification information for distinguishing the image data from another image data,
carrying out a search for one or more pieces of image data corresponding to one or more images, a part or entirety of which represents the character string that contains a specified keyword, and
changing, to the specified keyword, the identification information of image data selected from among said one or more pieces of image data found out by the search.

9. A method for managing image data in an image processing apparatus shared by a plurality of users, the method comprising:
causing the image processing apparatus to perform:
a reading process of reading an image, a part or entirety of which represents a character string,
an image data storage process of storing, in an image data storage portion, image data based on which the image thus read is reproduced in association with first identification information for distinguishing the image data from another image data,
a search process of carrying out a search for one or more pieces of image data corresponding to one or more images, a part or entirety of which represents the character string that contains a keyword specified by an active user among the plurality of users, the active user being a user who currently uses the image processing apparatus,
a keyword storage process of storing, in a keyword storage portion, the keyword in association with the active user and image data selected by the active user from among said one or more pieces of image data found out by the search, and
a first display process of displaying, if the keyword storage portion stores the keyword associated with the active user and the image data selected by the active user, the keyword to inform the active user of the image data, and displays, if the keyword storage portion does not store the keyword associated with the active user and the image data, the first identification information of the image data to inform the active user of the image data.

10. The method for managing image data according to claim 9, further comprising causing the image processing apparatus to perform an identification information storage process of storing, in an identification information storage portion, second identification information assigned to the image data by the active user in association with the image data and the active user, the second identification information being for distinguishing the image data from another image data,
wherein, if the identification information storage portion stores the second identification information associated with the image data and the active user, the image processing apparatus is caused to perform a second display process, instead of the first display process, of displaying the second identification information, instead of the keyword and the first identification information, to inform the active user of the image data.

11. The method for managing image data according to claim 9, further comprising causing the image processing apparatus to perform a transmission process of sending the image data selected by the active user from among said one or more pieces of image data found out by the search to another apparatus after assigning, to the image data selected by the active user, the keyword associated with the active user and the image data.

12. The method for managing image data according to claim 11, further comprising causing the image processing apparatus to perform an identification information storage process of storing, in an identification information storage portion, second identification information assigned to the image data by the active user in association with the image data and the active user, the second identification information being for distinguishing the image data from another image data,
wherein if the identification information storage portion stores the second identification information associated with the active user and the image data selected by the active user from among said one or more pieces of image data found out by the search, the transmission process includes sending the image data selected by the active user to another apparatus after assigning, to the image data selected by the active user, the second information instead of the keyword and the first identification information.

13. A method for managing image data in an image processing apparatus shared by a plurality of users, the method comprising:
causing the image processing apparatus to perform:
reading an image, a part or entirety of which represents a character string,
storing, in an image data storage portion, image data based on which the image thus read is reproduced in association with identification information for distinguishing the image data from another image data,
carrying out a search for one or more pieces of image data corresponding to one or more images, a part or entirety of which represents the character string that contains a keyword specified by an active user among the plurality of users, the active user being a user who currently uses the image processing apparatus,
storing, in a keyword storage portion, the keyword in association with the active user and image data selected by the active user from among said one or more pieces of image data found out by the search,
storing, in a second identification information storage portion, second identification information assigned to the image data by the active user in association with the image data and the active user, the second identification information being for distinguishing the image data from another image data, and
displaying a code including at least one of the keyword associated with the active user and the image data, the second identification information associated with the image data and the active user, and the first identification information of the image data to inform the active user of the image data.

14. A computer-readable storage medium storing thereon a computer program used in an image processing apparatus, the computer program causing the image processing apparatus to perform:
reading an image, a part or entirety of which represents a character string;
storing, in an image data storage portion, image data based on which the image thus read is reproduced in association with identification information for distinguishing the image data from another image data;
carrying out a search for one or more pieces of image data corresponding to one or more images, a part or entirety of which represents the character string that contains a specified keyword; and
changing, to the specified keyword, the identification information of image data selected from among said one or more pieces of image data found out by the search.

15. A computer-readable storage medium storing thereon a computer program used in an image processing apparatus shared by a plurality of users, the computer program causing the image processing apparatus to perform:
reading an image, a part or entirety of which represents a character string;
storing, in an image data storage portion, image data based on which the image thus read is reproduced in association with identification information for distinguishing the image data from another image data;
carrying out a search for one or more pieces of image data corresponding to one or more images, a part or entirety of which represents the character string that contains a keyword specified by an active user among the plurality of users, the active user being a user who currently uses the image processing apparatus;
storing, in a keyword storage portion, the keyword in association with the active user and image data selected by the active user from among said one or more pieces of image data found out by the search; and
displaying, if the keyword storage portion stores the keyword associated with the active user and the image data selected by the active user, the keyword to inform the active user of the image data, and displaying, if the keyword storage portion does not store the keyword associated with the active user and the image data, the first identification information of the image data to inform the active user of the image data.

16. The computer-readable storage medium according to claim 15, the program causing the image processing apparatus to further perform an identification information storage process of storing, in an identification information storage portion, second identification information assigned to the image data by the active user in association with the image data and the active user, the second identification information being for distinguishing the image data from another image data,
wherein, if the identification information storage portion stores the second identification information associated with the image data and the active user, the image processing apparatus is caused to perform a second display process, instead of the first display process, of displaying the second identification information instead of the keyword and the first identification information to inform the active user of the image data.

17. The computer-readable storage medium according to claim 15, the program causing the image processing apparatus to further perform a transmission process of sending the image data selected by the active user from among said one or more pieces of image data found out by the search to another apparatus after assigning, to the image data selected by the active user, the keyword associated with the active user and the image data.

18. The computer-readable storage medium according to claim 17, the program causing the image processing apparatus to further perform an identification information storage process of storing, in an identification information storage portion, second identification information assigned to the image data by the active user in association with the image data and the active user, the second identification information being for distinguishing the image data from another image data,
wherein if the identification information storage portion stores the second identification information associated with the active user and the image data selected by the active user from among said one or more pieces of image data found out by the search, the transmission process includes sending the image data selected by the active user to another apparatus after assigning, to the image data selected by the active user, the second information instead of the keyword and the first identification information.

19. A computer-readable storage medium storing thereon a computer program used in an image processing apparatus shared by a plurality of users, the computer program causing the image processing apparatus to perform:
reading an image, a part or entirety of which represents a character string,
storing, in an image data storage portion, image data based on which the image thus read is reproduced in association with first identification information for distinguishing the image data from another image data,
carrying out a search for one or more pieces of image data corresponding to one or more images, a part or entirety of which represents the character string that contains a keyword specified by an active user among the plurality of users, the active user being a user who currently uses the image processing apparatus,
storing, in a keyword storage portion, the keyword in association with the active user and image data selected by the active user from among said one or more pieces of image data found out by the search,
storing, in a second identification information storage portion, second identification information assigned to the image data by the active user in association with the image data and the active user, the second identification information being for distinguishing the image data from another image data, and
displaying a code including at least one of the keyword associated with the active user and the image data, the second identification information associated with the image data and the active user, and the first identification information of the image data to inform the active user of the image data.
